(19) United States
(12) Patent Application Publication
(10) Pub. No.: US 2012/0253703 A1
(43) Pub. Date: Oct. 4, 2012

(54) TORQUE DISPLAY SYSTEM AND METHOD THEREOF

(76) Inventors: Hsiu-Feng CHU, Taoyuan County (TW); Che-Min LIN, Taoyuan County (TW)

(21) Appl. No.: 13/370,499

(22) Filed: Feb. 10, 2012

(30) Foreign Application Priority Data
Mar. 28, 2011 (TW) 100110539
Oct. 3, 2011 (TW) 100135811

(51) Int. Cl. G01L 5/24; G06F 19/26

(52) U.S. Cl. 702/43

(57) ABSTRACT

The present invention discloses a torque display system and a method thereof. This system comprises an input unit, an operation unit, a memory unit, a display unit and a warning unit. The input unit is used to receive a torque signal sensed by the torque tool with or without a torque multiplier and receive a magnification parameter value inputted by the user according to the torque multiplier selected. The operation unit is used to compute a magnified torque value according to the torque signal and magnification parameter value. The display unit is used to display the preset torque value, the magnified torque value and the magnification parameter value inputted. The warning unit is used to alert the user that the preset torque value is reached and the computation of the magnified torque value is completed. The memory unit is used to save magnification parameter values of several torque multipliers.

### CROSS-REFERENCE TO RELATED APPLICATION

This application claims the benefit of Taiwan Patent Application No. 110110539, filed on Mar. 28, 2011, and No. 100135811, filed on Oct. 3, 2011, in the Taiwan Intellectual Property Office, the disclosure of which is incorporated herein in its entirety by reference.

### BACKGROUND OF THE INVENTION

1. Field of the Invention

The present invention relates to a torque display system and the method thereof applicable to a digital display type torque tool or a digital display type torque testing instrument that can display a magnified torque value correctly and instantly, in particular to a torque display system and the method thereof that can display the actual magnified torque value coupled with the torque multiplier without requiring any manual calculation, such that if the torque applied to the torque tool exceeds the torque limit of the torque tool, the torque will be recorded and a warning unit will alert users by a buzz or light while displaying on a display device simultaneously, so as to extend the service life of the torque tool and clarify the attribution of responsibility for product warranty.

2. Description of the Related Art

Torque refers to a force occurred when an object is rotated, and the magnitude of the torque is defined as the product of the force and the arm of the force in physics, and measured in the unit of Nm (Newton-meter) or any other equivalent torque unit. In our daily life, a torque wrench may be used for tightening or loosening a fastener (screw or bolt), and the rotating power is a torque.

At present, various kind of tools are available in the market for measuring and displaying the magnitude of the torque, such as a digital display type torque wrench and a digital display type torque testing instrument, and related data (such as the torque and angle) produced by the driving torque are displayed by a digital module, but such digital modules can only display the torque value corresponding to the sensing range of the sensing components originally designed for the torque wrench or instrument. Since the design of a general torque securing tool is limited by the structural strength of the torque tool, the specification and capacity of the sensing components, therefore the torque sensing capability is very limited. If it is necessary to apply a large torque for an object securing operation, a torque multiplier is generally required and installed at the torque output end of the torque tool for magnifying the driving torque, and the magnified torque value need to be calculated manually or by a calculating tool, wherein an input torque value is multiplied by the magnification ratio of the torque multiplier to obtain the magnified torque value. However, the magnified torque value cannot be calculated instantly and displayed on the original display device. In addition, if the torque testing instrument with a smaller torque calibration capability to be used for measuring or calibrating a torque tool with a larger torque, such that the torque tool to be tested is much greater than the capacity of the torque testing instrument to be used. As a result, the measurement or calibration cannot be conducted accordingly. Since the transmission mechanism by the gear train inside the torque multiplier definitely have a loss of transmission efficiency during the operation process, so that the magnified torque value cannot be converted according to the nominal magnification ratio of the torque multiplier directly and need to be calculated according to the actual calibrated magnification parameter value (P) of each individual torque multiplier instead so as to obtain a correct magnified torque value (T).

The objective of the present invention is to design a torque display system and the method thereof for a digital display type torque tool or a digital display type torque testing instrument while coupling to a torque multiplier in work, such that an accurate magnified torque value can be computed and displayed instantly without any manual calculation. In addition, the digital display type torque tools or torque testing instrument may be damaged easily due to improper use (such as applying a torque exceeding the torque limit of its design), thus resulting in customer complaints and disputes. The present invention can provide a solution to prevent the torque tool from abusing by improper torque applied and by using the built-in input, computing, storage, display and warning devices of the system to record the condition when the torque applied to the torque tool exceeds its torque limit while using the warning unit to alert the user by buzz or light immediately and display the condition on the display device, so as to extend the service life of the torque tool and clarify the attribution of responsibility for product warranty.

### SUMMARY OF THE INVENTION

In view of the shortcomings of the prior art, it is a primary objective of the present invention to provide a torque display system and the method thereof for displaying torque to overcome the conventional torque tool that cannot display the torque value magnified by the torque multiplier directly and instantly.

Another objective of the present invention is to provide a torque display system and the method thereof, such that a torque testing instrument with a smaller calibration capacity can couple to a torque multiplier with an appropriate magnification ratio to calibrate a torque tool with much higher torque.

Another objective of the present invention is to provide a torque display system and the method thereof, for a torque tool with a smaller torque capacity to check the torque applied to a fastener (such as a bolt which was tightened with much higher torque) while coupling to a torque multiplier with an appropriate magnification ratio.

Another objective of the present invention is to alert users and record the condition timely when a torque applied to the torque tool exceeds its torque limit, so as to extend the service life of the torque tool and clarify the attribution of responsibility for product warranty.

Another objective of the present invention is to provide a torque display system comprising an input unit, an operation unit, a display unit and a warning unit. The operation unit is coupled to the input unit, the display unit and the warning unit. The input unit is provided for receiving a torque signal sensed by a torque tool that is selectively coupled to a torque multiplier and receiving a preset torque value inputted by a user or a magnification parameter value corresponding to the torque multiplier. The operation unit computes a torque value according to a sensed torque signal sensed by the torque tool when the torque tool is not coupled to a torque multiplier. Similarly, the operation unit computes a magnified torque value corresponding to a torque multiplier according to a sensed torque signal sensed by the torque tool and a calibrated magnification parameter value inputted by a user when the torque tool is coupled to a torque multiplier. The display unit is provided for displaying the torque value, the preset torque value, the magnification parameter value, the magnified torque value, the limit torque value of the torque tool, the torque value greater than the limit torque value, or the magnified torque value greater than the torque limit. The warning unit is provided for alerting a condition that the computation of the torque value or magnified torque value is completed, or the torque value or the magnified torque value reaches the preset torque value, or the torque value or magnified torque value is approaching or greater than the limit torque value.

Preferably, the torque display system of the present invention may further comprises a memory unit coupled to the operation unit for saving a plurality of magnification parameter values corresponding to various model numbers of the torque multipliers, and users can select one of the magnification parameter values by the input unit.

Preferably, if the input unit receives a model number corresponding to a torque multiplier and inputted by a user, the operation unit will compute the corresponding magnification parameter value according to the model number of the torque multiplier, display the magnification parameter value on the display unit, and save the magnification parameter value in the memory unit.

Preferably, the limit torque value is saved in the memory unit, and the memory unit is further used for recording a torque value or a magnified torque value greater than the limit torque value.

Wherein, the input unit is a plurality of input keys or a connector capable of connecting to an external torque signal.

Preferably, the operation unit may further determines if the torque tool needs to be connected to a torque multiplier and use a magnification mode for the object securing operation in order to reach the preset torque value according to the inputted preset torque value and the limit torque value; if yes, then the operation unit will display the model number or the corresponding magnification parameter value of the built-in torque multiplier saved in the memory unit on the display unit to remind the user.

Preferably, the torque display system may further comprise an angular motion sensing unit. The angular motion sensing unit continuously sends an angular motion sensing signal to the input unit so as to configure the operation unit to compute an instantaneous torque value corresponding to the angular movement of the torque tool according to the angular motion sensing signal.

In an embodiment, the input unit continuously receives the angular motion sensing signal. When the user uses the torque tool selectively coupled to the torque multiplier to detect the tightening torque of a fastener and the angular movement that the user rotates the torque tool reaches a predetermined angular movement, the operation unit computes a first instantaneous torque value applied on the torque tool or the torque multiplier at the moment according to the torque signal sensed by the input unit. The display unit displays the first instantaneous torque value and the predetermined angular movement.

In an embodiment, when the angular movement that the user rotates the torque tool exceeds the predetermined angular movement, the operation unit not only computes the first instantaneous torque value applied on the torque tool or the torque multiplier at the moment that the user rotated the torque tool to the predetermined angular movement, but also computes the second instantaneous torque value applied on the torque tool or the torque multiplier at the moment that the user rotated the torque tool to a final angular movement as soon as the tool stop rotating, and the display unit displays or alternately displays the first instantaneous torque value, the predetermined angular movement, the second instantaneous torque value and the final angular movement.

In an embodiment, when the user inputs the predetermined angular movement and a qualified torque value range, and rotates the torque tool to the predetermined angular movement to detect the tightening torque of the fastener, the operation unit computes the first instantaneous torque value applied on the torque tool or the torque multiplier at the moment that the user rotated the torque tool to the predetermined angular movement, and compares the first instantaneous torque value with qualified torque value range to display the comparison result on the display unit.

Preferably, the warning unit may include a buzzer or a warning light.

Preferably, the display unit may be a liquid crystal display.

Another objective of the present invention is to provide a torque display method applicable for a digital display type torque tool or torque testing instrument, and the torque display method comprises the following steps: An input unit receives a preset torque value inputted by a user. The input unit receives a torque signal sensed by the torque tool or torque testing instrument which is selectively coupled to a torque multiplier, or further receives a magnification parameter value corresponding to a torque multiplier which is inputted by the user or selected from a memory unit. An operation unit computes a torque value according to a torque signal sensed by the torque tool or torque testing instrument which is not coupled to the torque multiplier. Similarly, the operation unit computes a magnified torque value that can be magnified by the torque multiplier according to a torque signal sensed by the torque tool or torque testing instrument which is coupled to the torque multiplier or a magnification parameter value inputted by the user. A display unit displays the torque value, the preset torque value, the magnified torque value, the magnification parameter value, a limit torque value of the torque testing instrument or the torque tool, the torque value greater than the limit torque value, or the magnified torque value greater than the limit torque value. A warning unit uses sound or light to alert a condition that the computation of a torque value or magnified torque value is completed, or a preset torque value is reached.

Preferably, if the input unit receives a model number corresponding to the torque multiplier and inputted by the user, the operation unit will compute the magnification parameter value of the torque multiplier according to the model number, display the magnification parameter value on the display unit, and save the magnification parameter value in the memory unit.

Preferably, the limit torque value is saved in the memory unit. If the torque value or magnified torque value is approaching or greater than the limit torque value, the warning unit will issue a warning signal, and the memory unit will record the torque value or magnified torque value which is greater than limit torque value.

Preferably, the operation unit further determines if it is necessary to couple the torque tool or torque testing instrument to a torque multiplier in order to reach the preset torque value according to the inputted preset torque value and limit torque value; if yes, then the model number or the magnification parameter value of the torque multiplier that can reach the preset torque value will be displayed on the display unit.

In the torque display system and the method thereof in accordance with the present invention, the logical operation unit of the torque display device of various digital display type torque tools has an automatic computation or determination function to remind users if it is necessary to add a torque multiplier with an appropriate magnification to carry out different object torque securing operations. As long as the model number of the torque multiplier is selected or the magnification parameter value matched with the torque multiplier is inputted, an actual accurate magnified torque value amplified by the torque multiplier can be displayed on the display device immediately to save the computing effort and time and avoid possible errors from the manual calculation.

Wherein, the torque display system of the present invention is applicable to various digital display type torque testing instruments. The torque display system of the present invention is applied to torque testing instruments for calibrating a torque securing tool having a large torque while coupling to a torque multiplier or calibrating a torque multiplier with an unknown magnification parameter value.

Preferably, the torque display system of the present invention is applicable to various models of digital display type torque tools or digital display type torque testing instruments which are manual, electric, pneumatic and hydraulic driving tools, such that the system can display an accurate torque value magnified by a torque multiplier coupled to the torque tool when a torque securing operation is performed. In addition, the torque display system alerts, records, and displays the value of a torque that exceeds the limit torque value. Thus, the torque display system with the present invention can extend the service life of the torque tool effectively, and provide records or evidences to prevent customer complaints and disputes with regard to quality and clarify the attribute of responsibility for product warranty.

### BRIEF DESCRIPTION OF THE DRAWINGS

FIG. 1 is a schematic view of a torque display system in accordance with a first preferred embodiment of the present invention;

FIG. 2 is a flow chart of a torque display system and the method thereof in accordance with a second preferred embodiment of the present invention;

FIG. 3 is a schematic view of a torque display system and the method thereof in accordance with a third preferred embodiment of the present invention;

FIG. 4 is a flow chart of a torque display system and the method thereof in accordance with a third preferred embodiment of the present invention;

FIG. 5 is a schematic view of a torque display system and the method thereof in accordance with a fourth preferred embodiment of the present invention;

FIG. 6 is a flow chart of a torque display system and the method thereof in accordance with a fourth preferred embodiment of the present invention;

FIG. 7 is a flow chart of a torque display system and the method thereof in accordance with a fifth preferred embodiment of the present invention;

FIG. 8 is a flow chart of a torque display system and the method thereof in accordance with a sixth preferred embodiment of the present invention;

FIG. 9 is a schematic view of a torque display system and the method thereof in accordance with a seventh preferred embodiment of the present invention;

FIG. 10 is a flow chart of a torque display system and the method thereof in accordance with a seventh preferred embodiment of the present invention;

FIG. 11 is a flow chart of a torque display system and the method thereof in accordance with an eighth preferred embodiment of the present invention; and

FIG. 12 is a flow chart of a torque display system and the method thereof in accordance with a ninth preferred embodiment of the present invention.

FIGS. 13A and 13B are flow charts of a torque display system and the method thereof in accordance with a tenth preferred embodiment of the present invention.

### DETAILED DESCRIPTION OF THE PREFERRED EMBODIMENTS

The technical characteristics and contents of the present invention will become apparent with the following detailed description and related drawings. It is noteworthy to point out that same numerals are used for representing respective same elements in the drawings.

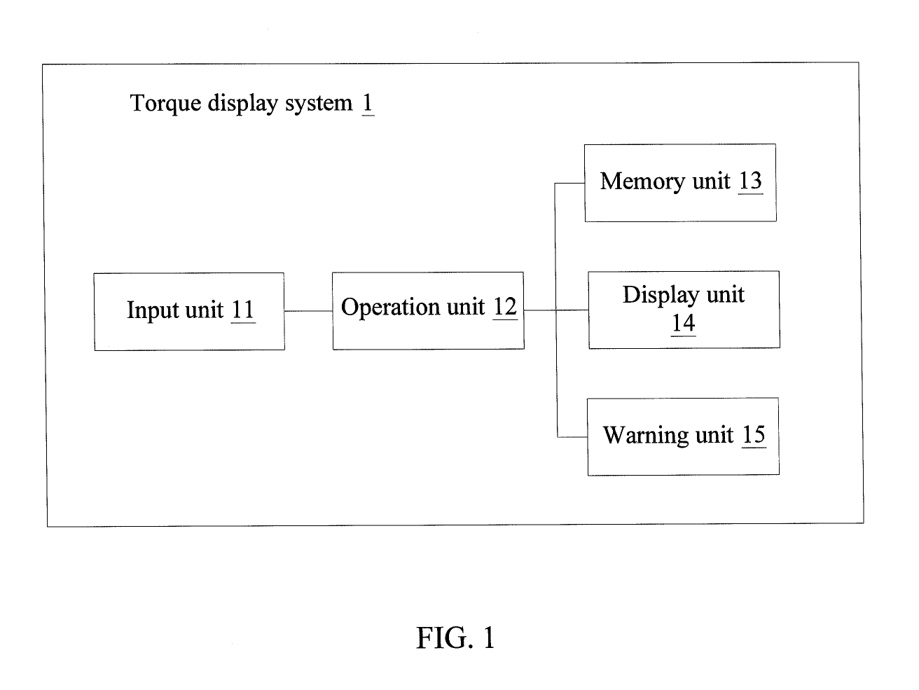

With reference to FIG. 1 for a schematic view of a torque display system in accordance with a preferred embodiment of the present invention, the torque display system 1 comprises an input unit 11, an operation unit 12, a memory unit 13, a display unit 14 and a warning unit 15. The operation unit 12 is coupled to the input unit 11, the memory unit 13, the display unit 14 and the warning unit 15, wherein the display unit 14 can be a liquid crystal display, and the warning unit 15 can be a light, a buzzer or a combination of the above. The torque display system 1 of the present invention is applicable to a digital display type torque tools or a digital display type torque testing instrument including the manual, electric, pneumatic, hydraulic driving types. The digital display type torque tool or the digital display type torque testing instrument installed to the torque display system 1 of the present invention can be coupled to a torque multiplier. The input unit 11 can be a plurality of input keys or a connector externally coupled to a torque signal, and provided for a user to input a preset torque value, a model number of the torque multiplier, or a corresponding magnification parameter value of the torque multiplier. The operation unit 12 compares the limit torque value of the torque tool with the inputted preset torque value to determine if a magnification mode is required for the object securing operation. If a torque multiplier is required, then a magnified torque value that can be magnified by this torque multiplier is computed according to the torque signal received after a torque is applied and the magnification parameter value inputted. When the magnified torque value reaches the preset torque value and the magnified torque value will be displayed on the display unit 14 immediately. The display unit 14 also displays a preset torque value inputted by the user or a model number and a corresponding magnification parameter value of a torque multiplier to be coupled to the torque tool. If the magnified torque value is computed and reaches the preset torque value, the warning unit 15 will alert the user by sound, light, or both.

Wherein, the memory unit 13 provides users a magnification parameter value of the torque multiplier calibrated by the original manufacturer and pre-stored in the memory 13. Similarly, the user can choose a torque multiplier and save the magnification parameter value thereof in the memory unit 13 after calibration.

Wherein, if a torque tool not coupled to the torque multiplier is used for securing an object, the operation unit 12 will convert a torque signal received by the input unit 11 into a torque value, and display the torque value on the display unit 14. Regardless of whether or not the torque tool is coupled to the torque multiplier, the input unit 11 can be provided for users to input a preset torque value (that is the value of a torque to be applied to the object in order to secure the object). While the operation unit 12 computes to determine if it is necessary to use a magnification mode of the torque tool (which means that a torque multiplier is required) for the object securing operation according to the inputted preset torque value, the display unit 14 displays the required and recommended model numbers of the torque multipliers or the magnification parameter values. The warning unit 15 alerts the user that the magnification mode is activated by sound or light signifying the magnification mode when the operation unit 12 determines that a torque multiplier is required.

From the description above, the operation of the torque display system of the present invention mainly comprises the tightening mode (including the standard mode and the magnification mode) and the calibrating mode.

Wherein, the standard mode refers to an operating mode that the operation unit 12 computes and determines that it is not necessary to add a torque multiplier to the torque tool for the object securing operation according to the inputted preset torque value. (the inputted preset torque value<the limit torque value of this torque tool) The warning unit 15 shows the light indicating the standard mode to notify the user.

Wherein, the magnification mode refers to an operating mode when the operation unit 12 computes and determines that it is necessary to couple the torque multiplier to the torque tool for the object securing operation according to the inputted preset torque value (the inputted preset torque value>the limit torque value of this torque tool). The warning unit 15 shows the light indicating that the magnification mode is required, and the display unit 14 displays the required and recommended model numbers of the torque multipliers and the corresponding magnification parameter value.

Wherein, the calibration mode is used for the user to use the system and method of the present invention to calibrate a torque multiplier and a torque tool with a large torque in order to obtain the magnification parameter values thereof when the user does not know the actual accurate magnification parameter value of the torque multiplier or it is necessary to calibrate the torque multiplier for the accurate magnification parameter value thereof or the user uses a torque testing instrument with a small torque testing capacity to calibrate the torque tool with a large torque.

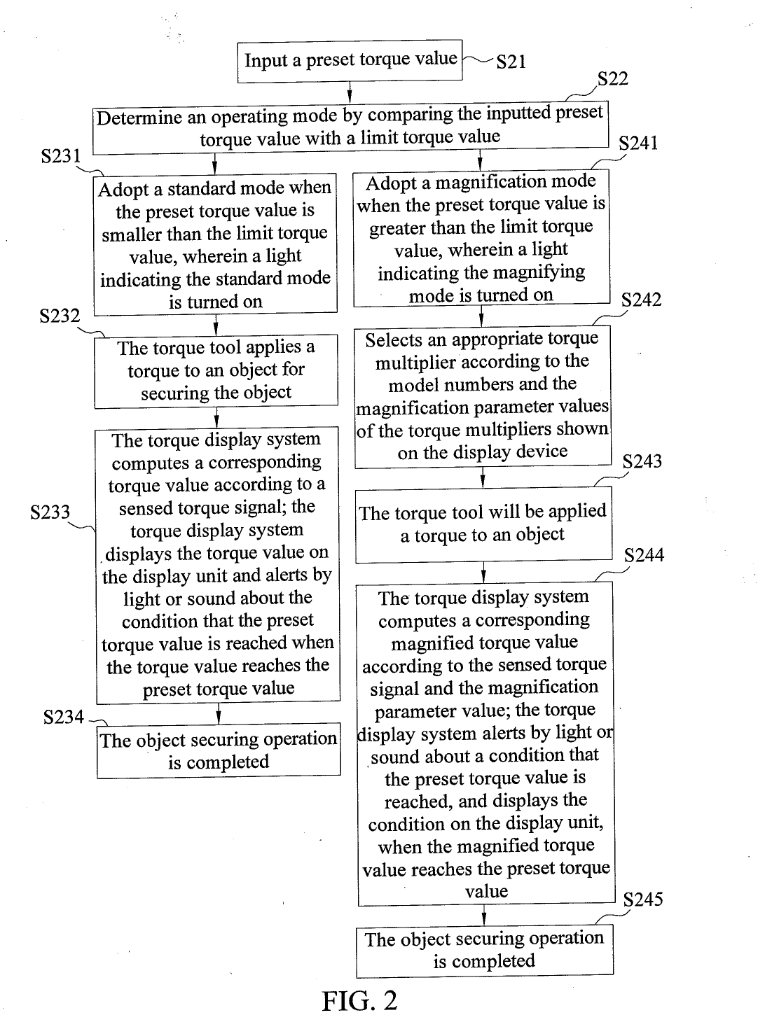

With reference to FIG. 2 for a flow chart of a torque displaying system and the method thereof in accordance with first and second preferred embodiments of the present invention, this is an operating flow of the securing mode, the method comprises the following steps: S21: A user inputs a preset torque value. S22: The torque display system uses the operation unit to determine and select a standard mode or a magnification mode for carrying out the object securing operation according to the condition that the preset torque value inputted is greater or smaller than the limit torque value of this torque tool, and the following description are two preferred embodiment for operating procedure.

In a first preferred embodiment, the following steps are carried out. S231: if the preset torque value is smaller than the limit torque value of this torque tool, then the standard mode is adopted, and the light indicating the standard mode is turned on. S232: The torque tool applies a torque to an object for securing the object. S233: The torque display system computes a corresponding torque value according to the sensed torque signal, and displays the torque value on the display unit; the torque display system alerts the user that the preset torque value is reached when the torque value reaches the preset torque value. S234: The object securing operation is completed.

In a second preferred embodiment, the following steps are carried out. 5241: When the preset torque value is greater than the limit torque value of this torque tool, then the magnification mode is adopted, and the light indicating the magnification mode is turned on. S242: The user selects an appropriate torque multiplier according to the model number of the torque multiplier and the magnification parameter value shown on the display device. Then, have it coupled to the torque tool. S243: The torque tool applies a torque to an object for securing the object. S244: The torque display system computes a corresponding magnified torque value according to the sensed torque signal and the magnification parameter value. The torque display system alerts by light or sound about a condition that the preset torque value is reached, and displays the condition on the display unit, when the torque value reaches the preset torque value. S245: The object securing operation is completed.

The calibration mode refers to an operating mode for the user to calibrate the chosen torque multipliers of different brands or different magnifications in order to confirm the actual magnification parameter values thereof and save the values in the memory unit before the user uses the torque multipliers for the object securing operation and measures the torque value. The measuring tool used for calibrating the torque multiplier can be a calibrated digital display type torque tool, a torque transducer, or a calibration instrument and so on.

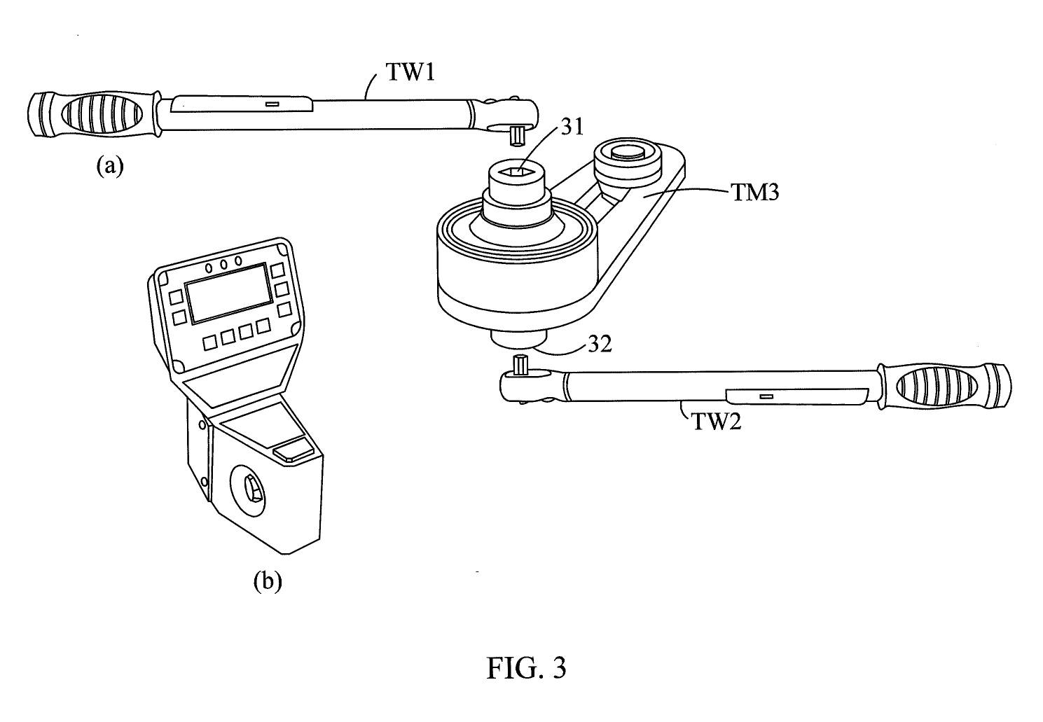

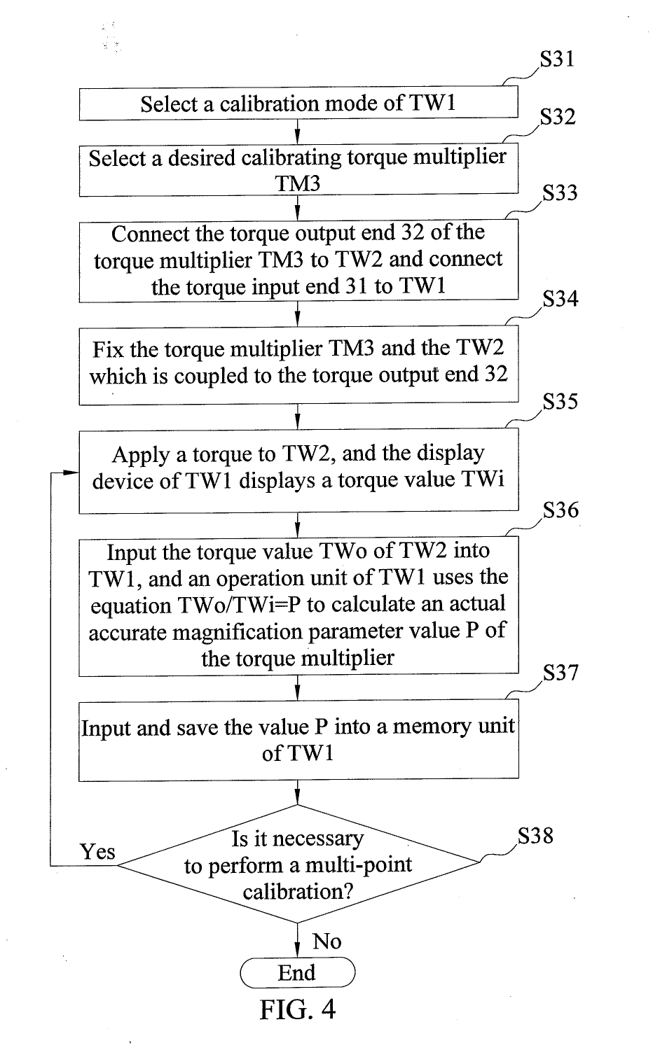

With reference to FIGS. 3 and 4 for a schematic view and a flow chart of a torque display system and the method in accordance with a third preferred embodiment of the present invention respectively, a torque multiplier TM3 with an unknown magnification parameter value (P) is used as an example for a calibration. In a calibration method, a calibrated digital display type torque tool which has a system of the present invention as shown in FIG. 3(a) or torque testing instrument as shown in FIG. 3(b) TW1 together with a calibrated standard torque measuring tool TW2 are used for calibrating a torque multiplier TM3 with an unknown torque magnification parameter value. In the calibrated digital display type torque tool TW1 which has the system of the present invention, input keys are used for selectively switching the operating mode to a calibrating mode, and the procedure comprises the following steps: S31: Select a calibration mode. S32: Select a desired calibrating torque multiplier TM3 of specific brand. S33: Connect the torque output end 32 of the desired calibrating torque multiplier TM3 to a calibrated torque measuring tool TW2, and connect the torque input end 31 of the torque multiplier TM3 to another calibrated digital display type torque tool TW1 having the system of the present invention. S34: Fix the desired calibrating torque multiplier TM3 and the calibrated standard torque measuring tool TW2 coupled to the torque output end 32. S35: Apply a torque TWo to the calibrated standard torque measuring tool TW2, such that a torque value TWi is obtained from digital display type torque tool TW1 having the system of the present invention. S36: An input unit of the calibrated digital display type torque tool TW1 having the system of the present invention is provided for inputting the torque value TWo of the calibrated standard torque measuring tool TW2 to a display device of the calibrated digital display type torque tool TW1 having the system of the present invention, and an operation unit of the calibrated digital display type torque tool TW1 having the system of the present invention can use the equation TWo/TWi=P to calculate an actual accurate magnification parameter value P corresponding to the desired calibrating torque multiplier TM3. S37: A memory unit of the calibrated digital display type torque tool TW1 having the system of the present invention saves the magnification parameter value P, and the display unit of the calibrated digital display type torque tool TW1 having the system of the present invention displays the calculated magnification parameter value P and the model number of the desired calibrating torque multiplier TM3 at the same time, while a warning unit of the calibrated digital display type torque tool TW1 having the system of the present invention alerts the user by light or sound about the condition that the calibration is completed. S38: Determine whether or not to perform a multi-point calibration; if yes, then repeat Steps S35 to S37. The steps S35 to S37 are repeated for carrying out a multi-point calibration of the same desired calibrating torque multiplier TM3, and the operation unit of the calibrated digital display type torque tool TW1 having the system of the present invention computes an average magnification parameter value (P) for each time according to the cumulative multi-point calibration values and saves the average magnification parameter value (P) in the memory unit. The calibration mode with the specification such as BS EN26789 and IS06789 is used for performing the calibration.

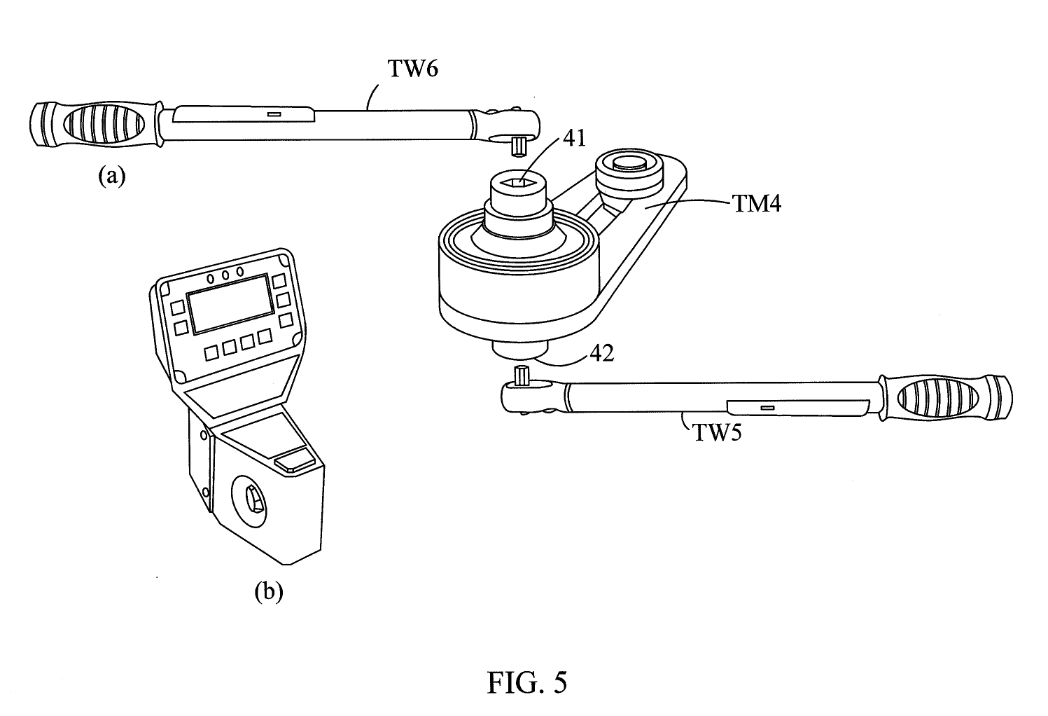

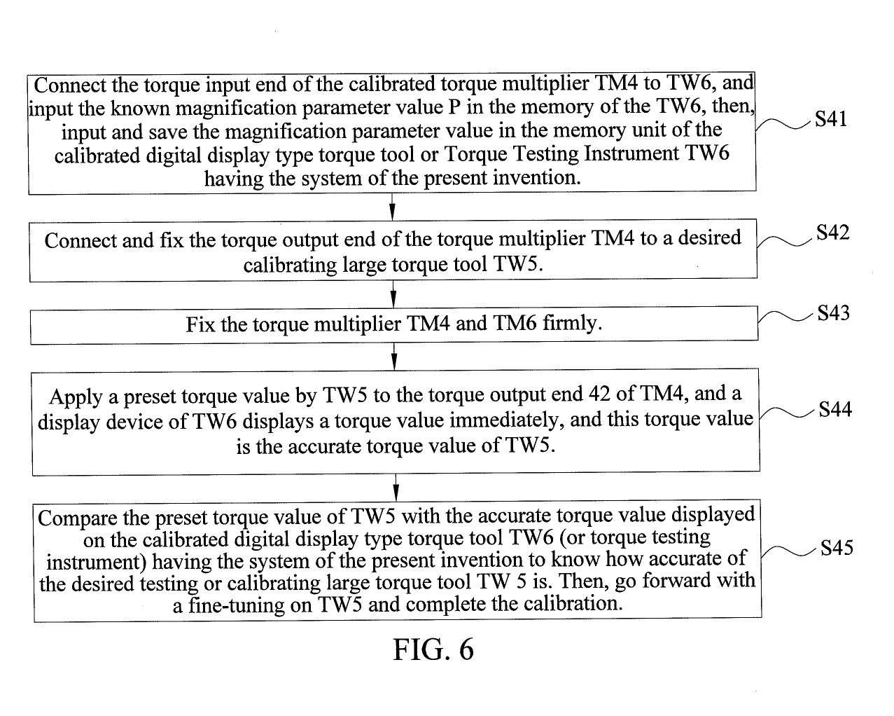

With reference to FIGS. 5 and 6 for a schematic view and a flow chart of a torque display system and the method thereof in accordance with a fourth preferred embodiment of the present invention respectively, this is an embodiment of another calibration mode to calibrate a torque with much higher torque value. The method of the invention comprises the following steps: S41: Connect the torque input end 41 of the calibrated torque multiplier TM4 to TW6, and input the known magnification parameter value P in the memory of the TW6, then, input and save the magnification parameter value in the memory unit of the calibrated digital display type torque tool (as shown in FIG. 5(a)) or Torque Testing Instrument (as shown in FIG. 5(b)) TW6 having the system of the present invention. S42: Connect and fix the torque output end 42 of the torque multiplier TM4 to a desired calibrating large torque tool TW5. S43: Fix the torque multiplier TM4 and TM6 firmly. S44: Apply a preset torque value by TW5 to the torque output end 42 of TM4, and a display device of TW6 displays a torque value immediately, and this torque value is the accurate torque value of TW5. S45: Compare the preset torque value of TW5 with the accurate torque value displayed on the calibrated digital display type torque tool TW6 (or torque testing instrument) having the system of the present invention to know how accurate of the desired testing or calibrating large torque tool TW5 is. Then, go forward with a fine-tuning on TW5 and complete the calibration.

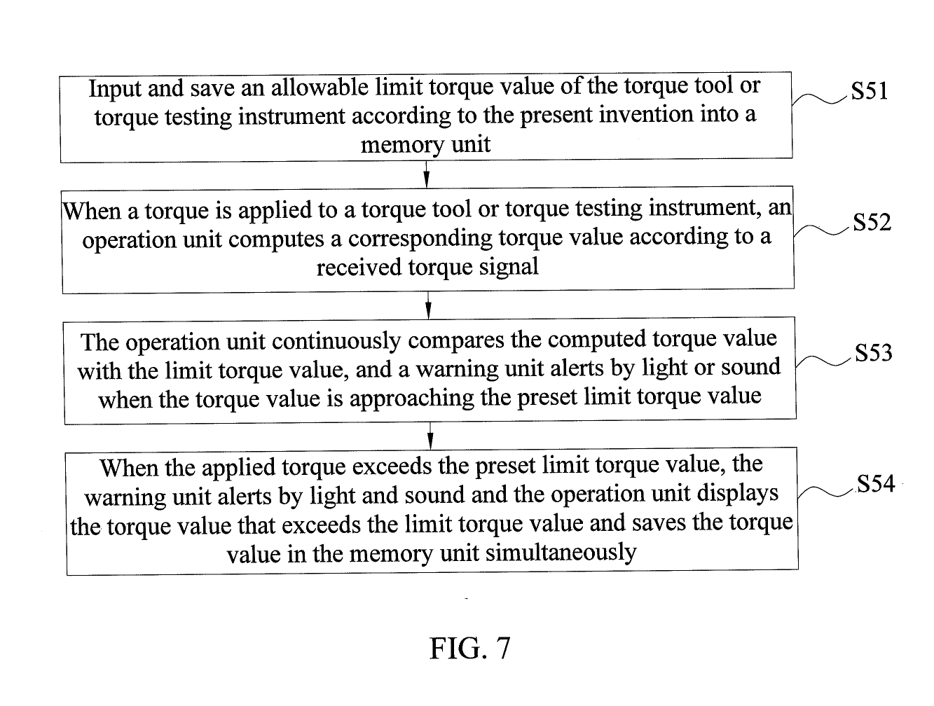

With reference to FIG. 7 for a flow chart of a torque display system and the method thereof in accordance with a fifth preferred embodiment of the present invention, when a torque applied on a torque tool having a torque display system of the present invention exceeds the limit torque of the torque tool, then the torque display system records and alerts the condition. The procedure comprises the following steps: S51: The torque tool or torque testing instrument having the torque display system of the present invention is inputted an allowable limit torque value of this torque tool from an input unit, and the limit torque value is saved in a memory unit. S52: when a torque is applied to a torque tool (or a torque testing instrument) having the system of the present invention, an operation unit of the torque display system of the present invention continuously computes a torque value from a received torque signal. S53: The operation unit continuously compares the computed torque value with the limit torque value; a warning unit alerts by light or sound when the torque value is approaching the preset limit torque value. S54: When the applied torque exceeds the preset limit torque value, the warning unit alerts by light and sound. Meanwhile, the operation unit displays the torque value that exceeds the limit torque value and saves the torque value in the memory unit simultaneously.

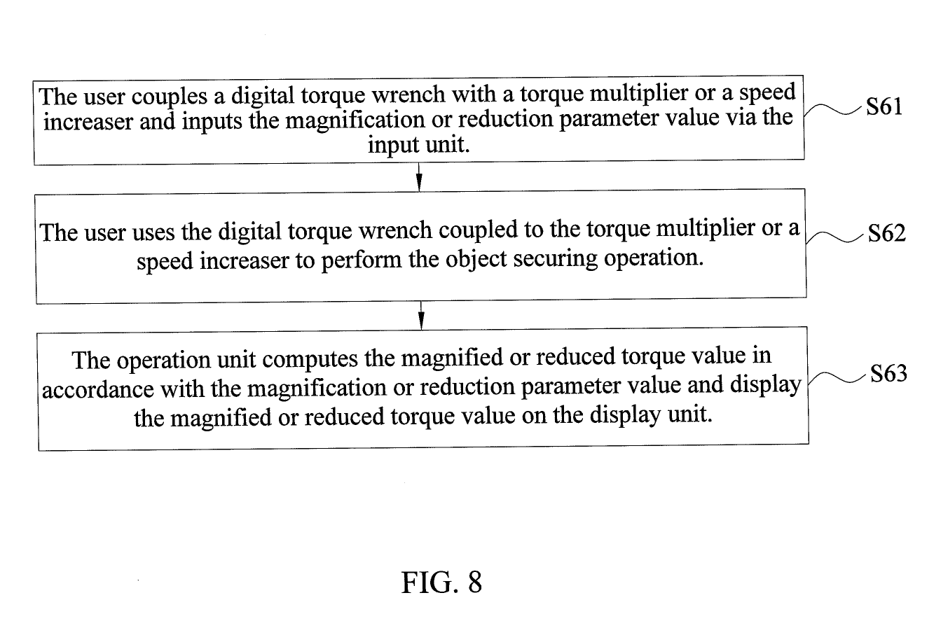

With reference to FIG. 8 for a flow chart of a torque display system and the method thereof in accordance with a sixth preferred embodiment of the present invention. One of the main objects of the magnification mode of the present invention is to magnify the torque driven by a digital display torque wrench which is coupled to a torque multiplier by a predetermined ratio, (the ratio>1) when the user uses the digital display torque wrench to perform the object securing operation. For example, when a digital display torque wrench with the torque display system according to the present invention is coupled to a torque multiplier or any effort-saving mechanism which extends the forced moment arm of the digital display torque wrench, the operation unit can automatically compute and display the magnified torque value on the display unit in no time. On the contrary, when the digital display torque wrench is coupled to a speed increaser or any device which decreases the forced moment arm of the digital display torque wrench in order to reduce the torque driven by the digital display torque wrench by a predetermined ratio (the ratio<1), the operation unit can also compute the reduced torque value and display the reduced torque value on the display unit.

To sum up, when the digital display torque wrench with the torque display system according to the present invention is coupled to various mechanism which magnifies or reduces the torque signal sensed by the digital display torque wrench in order to performs the object securing operation, the operation unit can automatically compute and display the magnified or reduced torque value in no time according to the inputted parameters regardless of the ratio being greater or less than 1. Thus, numerous modifications and variations could be made thereto by those generally skilled in the art without departing from the scope and spirit of the invention.

The embodiment includes the following steps: S61: the user couples a digital torque wrench with a torque multiplier or a speed increaser and inputs the magnification or reduction parameter value via the input unit. S62: the user uses the digital torque wrench coupled to the torque multiplier or a speed increaser to perform the object securing operation. S63: the operation unit computes the magnified or reduced torque value in accordance with the magnification or reduction parameter value and display the magnified or reduced torque value on the display unit. The aforementioned is just for an example. The present invention is not limited to such arrangement only. Numerous modifications and variations could be made thereto by those generally skilled in the art without departing from the scope and spirit of the invention.

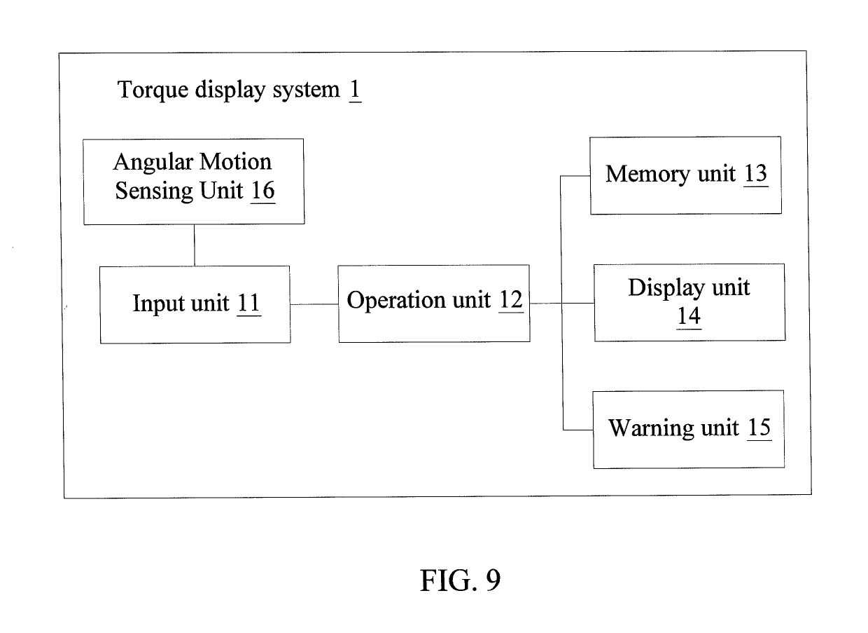

With reference to FIG. 9 for a schematic view of a torque display system and the method thereof in accordance with a seventh preferred embodiment of the present invention. The operation unit 12 of the present invention can compute a first instantaneous torque value according to a preset angular movement (which is the angular movement of the fastener on the resistance force point after the user applies a torque via the digital display torque wrench). In the embodiment, the user wants to use a digital display torque wrench capable of detecting angular movement to test a torque value applied to a fastener. When the angular movement of the mechanism on the resistance force point reaches a preset angular movement, the rotating mechanism of the digital display type torque tool with an angular motion sensing unit 16, (such as a variable resistor or a gyroscope) detects a angular motion signal and the digital display torque wrench detects a torque signal (which comes from the torque sensing unit of the digital display wrench, such as a strain gauge). In the meanwhile, the built-in input unit 11 captures the angular motion signal and the instantaneous torque signal corresponding to the angular motion signal. The operation unit 12 computes the first instantaneous torque value corresponding to the instantaneous torque signal and displays he first instantaneous torque value on the display unit 14.

Besides, when the angular movement that the user rotates the digital display wrench exceeds a predetermined angular movement, the operation unit not only computes the first instantaneous torque value, but also computes the second instantaneous torque value by the final angular movement detected as soon as the user stops rotating the digital display torque wrench. The display unit 14 displays or alternately displays the first instantaneous torque value, the predetermined angular movement, the second instantaneous torque value and the final angular movement.

Thus, the user can definitely determine the instantaneous torque value when the user rotates the digital display torque wrench to the predetermined angular movement. The prior-art torque wrench has inferior accuracy than the present invention because the prior art torque wrench only depends on sound effects or light to remind the user or the user has to figure approximately the angular movement by visual observation.

The present invention takes advantage of the angular motion sensing unit 16 attached on the digital display torque wrench to continuously send the angular motion signal to the input unit 11. When the angular motion signal reaches the predetermined angular movement, the input unit 11 captures the angular motion signal and the torque signal simultaneously. The operation unit 12 computes the torque value corresponding to the angular movement and displays the computed torque value and the corresponding angular movement on the display unit 14 in no time. The user can still definitely determine the instantaneous torque value at the moment that the user rotates the digital display wrench to the predetermined angular movement, even if the user cannot be reminded by sound effects and light in time. Thus, the present invention can effectively improve the accuracy of the digital display torque wrench with the function of detecting the angular movement to calibrate the torque applied to a fastener. To sum up, the present invention can completely overcome the trouble that the user fails to determine the instantaneous torque value corresponding to the predetermined angular movement because the angular movement that the user rotates the digital display wrench tends to exceed the preset angular motion while calibrating the tightening torque of a fastener according to the predetermined angular movement.

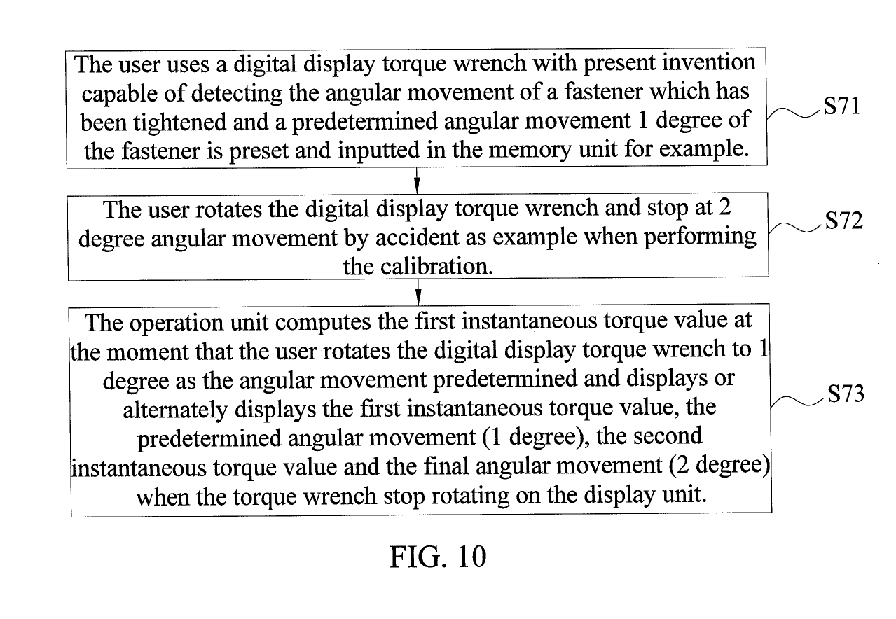

With reference to FIG. 10 for a flow chart of a torque display system and the method thereof in accordance with a seventh preferred embodiment of the present invention. The embodiment comprises the following steps: S71: The user uses a digital display torque wrench with present invention capable of detecting the angular movement of a fastener which has been tightened and a predetermined angular movement 1 degree of the fastener is preset and inputted in the memory unit for example. S72: The user rotates the digital display torque wrench and stop at 2 degree angular movement by accident as example when performing the calibration. S73: The operation unit computes the first instantaneous torque value at the moment that the user rotates the digital display torque wrench to 1 degree as the angular movement predetermined and displays or alternately displays the first instantaneous torque value, the predetermined angular movement (1 degree), the second instantaneous torque value and the final angular movement (2 degree) when the torque wrench stop rotating) on the display unit.

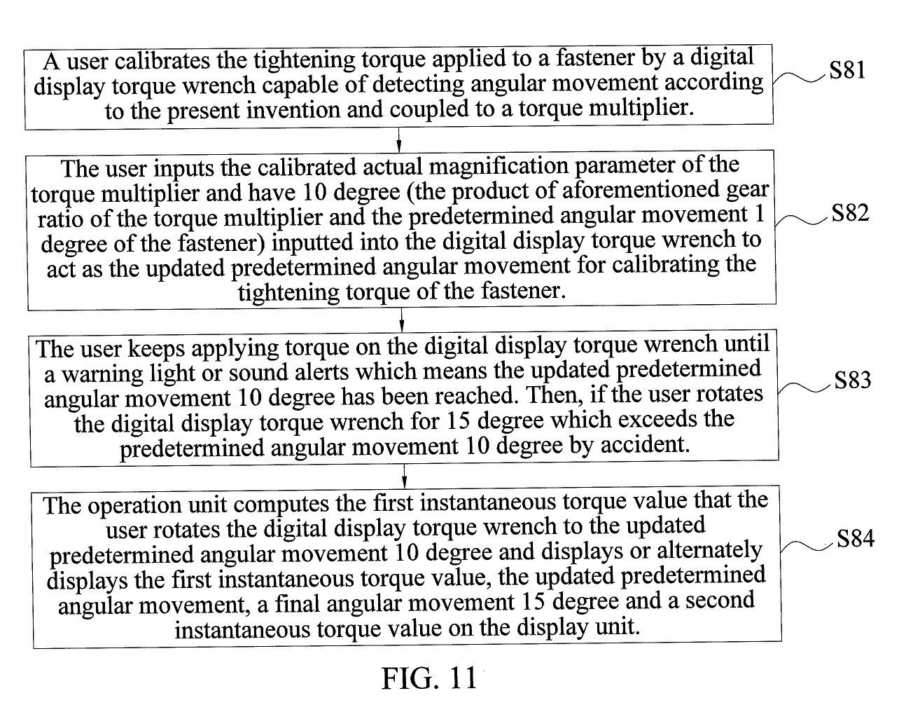

With reference to FIG. 11 for a flow chart of a torque display system and the method thereof in accordance with an eighth preferred embodiment of the present invention. The embodiment includes the following steps: S81: a user calibrates the tightening torque applied to a fastener by a digital display torque wrench capable of detecting angular movement according to the present invention and coupled to a torque multiplier with gear ratio 10:1 for example. S82: the user inputs the calibrated actual magnification parameter of the torque multiplier and have 10 degree (the product of aforementioned gear ratio of the torque multiplier and the predetermined angular movement 1 degree of the fastener) inputted into the digital display torque wrench to act as the updated predetermined angular movement for calibrating the tightening torque of the fastener. S83: the user keeps applying torque on the digital display torque wrench until a warning light or sound alerts which means the updated predetermined angular movement 10 degree has been reached. Then, if the user rotates the digital display torque wrench for 15 degree which exceeds the predetermined angular movement 10 degree by accident. S84: the operation unit computes the first instantaneous torque value that the user rotates the digital display torque wrench to the updated predetermined angular movement 10 degree and displays or alternately displays the first instantaneous torque value, the updated predetermined angular movement, a final angular movement 15 degree and a second instantaneous torque value on the display unit. In addition, the updated predetermined angular movement can be modified according to requirements.

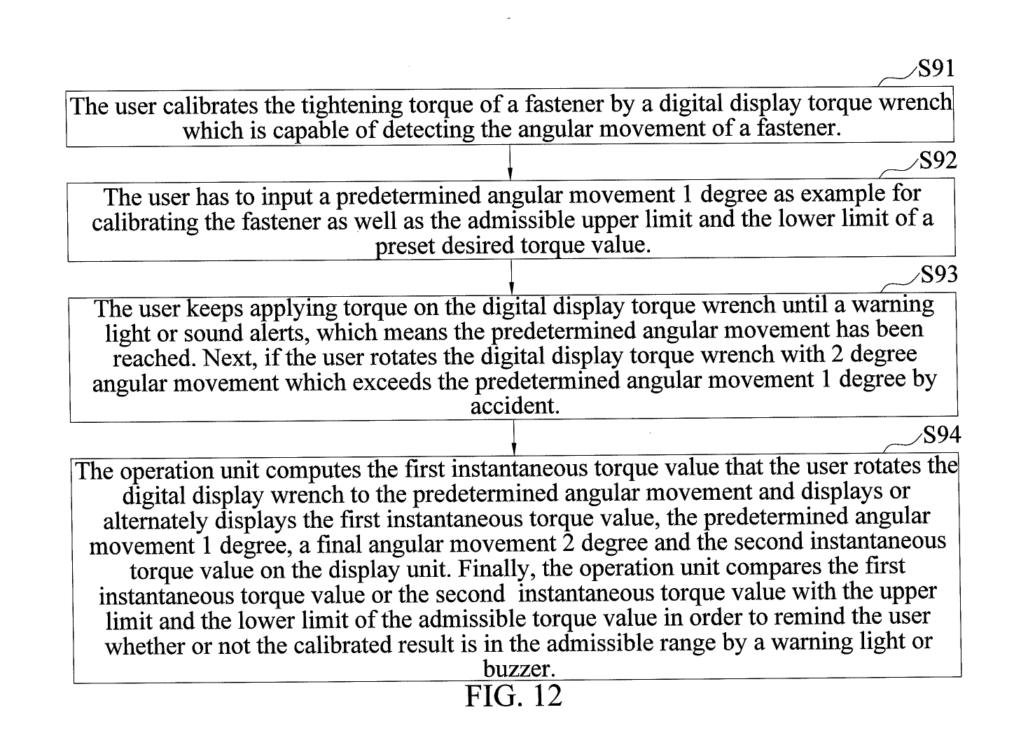

With reference to FIG. 12 for a flow chart of a torque display system and the method thereof in accordance with a ninth preferred embodiment of the present invention. The embodiment includes the following steps: S91: the user calibrates the tightening torque of a fastener by a digital display torque wrench which is capable of detecting the angular movement of a fastener according to the present invention. S92: the user has to input a predetermined angular movement 1 degree as example for calibrating the fastener as well as the admissible upper limit and the lower limit of a preset desired torque value. S93: the user keeps applying torque on the digital display torque wrench until a warning light or sound alerts, which means the predetermined angular movement has been reached. Next, if the user rotates the digital display torque wrench with 2 degree angular movement which exceeds the predetermined angular movement 1 degree by accident. S94: the operation unit computes the first instantaneous torque value that the user rotates the digital display wrench to the predetermined angular movement and displays or alternately displays the first instantaneous torque value, the predetermined angular movement 1 degree, a final angular movement 2 degree and the second instantaneous torque value on the display unit. Finally, the operation unit compares the first instantaneous torque value or the second instantaneous torque value with the upper limit and the lower limit of the admissible torque value in order to remind the user whether or not the calibrated result is in the admissible range by a warning light or buzzer.

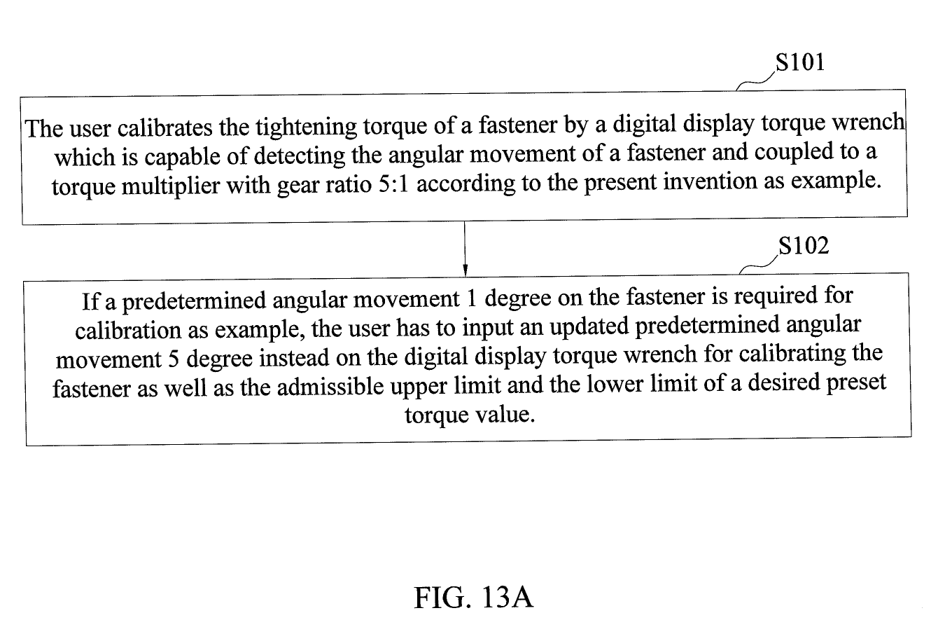

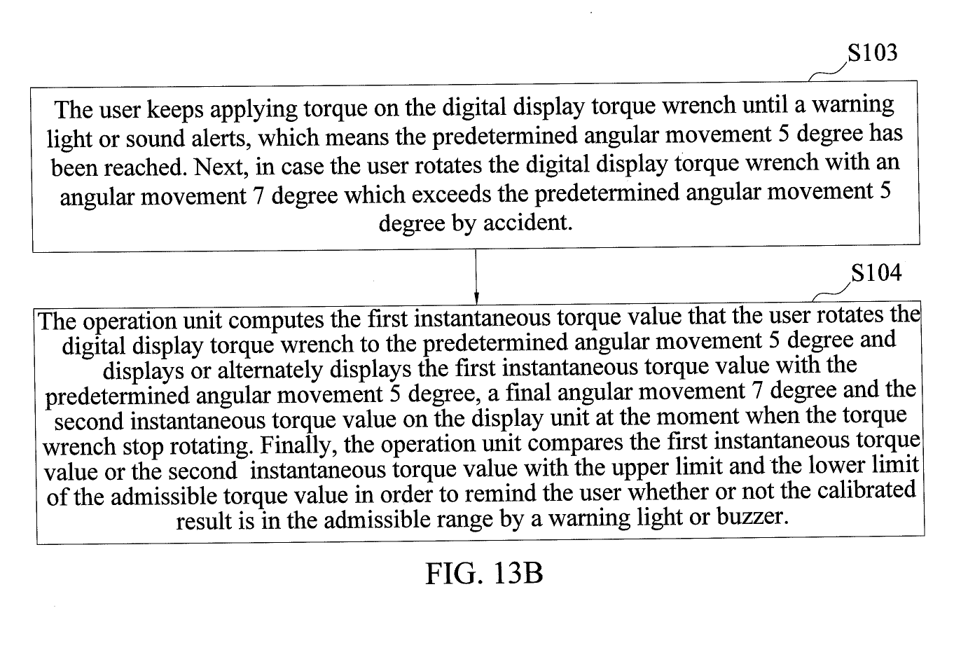

With reference to FIGS. 13A and 13B for a flow chart of a torque display system and the method thereof in accordance with a tenth preferred embodiment of the present invention. The embodiment includes the following steps: S101: the user calibrates the tightening torque of a fastener by a digital display torque wrench which is capable of detecting the angular movement of a fastener and coupled to a torque multiplier with gear ratio 5:1 according to the present invention as example. S102: If a predetermined angular movement 1 degree on the fastener is required for calibration as example, the user has to input an updated predetermined angular movement 5 degree instead on the digital display torque wrench for calibrating the fastener as well as the admissible upper limit and the lower limit of a desired preset torque value. S103: the user keeps applying torque on the digital display torque wrench until a warning light or sound alerts, which means the predetermined angular movement 5 degree has been reached. Next, in case the user rotates the digital display torque wrench with an angular movement 7 degree which exceeds the predetermined angular movement 5 degree by accident. S104: the operation unit computes the first instantaneous torque value that the user rotates the digital display torque wrench to the predetermined angular movement 5 degree and displays or alternately displays the first instantaneous torque value with the predetermined angular movement 5 degree, a final angular movement 7 degree and the second instantaneous torque value on the display unit at the moment when the torque wrench stop rotating. Finally, the operation unit compares the first instantaneous torque value or the second instantaneous torque value with the upper limit and the lower limit of the admissible torque value in order to remind the user whether or not the calibrated result is in the admissible range by a warning light or buzzer.

In summation of the description above, the torque display system and the method thereof in accordance with the present invention not only displays a corresponding torque value according to a sensed torque signal immediately when a torque is applied to the torque tool, but also uses logical operations to determine if it is necessary for the digital display type torque tool to couple to a torque multiplier in order to use a magnification mode to perform the object securing operation according to an inputted preset torque value which is higher than the limit torque of this digital display type torque tool. Moreover, the method of inputting a calibrated accurate magnification parameter in accordance with the present invention can directly compute and display the actual accurate torque value magnified by the torque multiplier without requiring any manual calculation. If the applied torque nearly exceeds the allowable limit torque value of the torque tool, a warning signal will be given in advance, so as to extend the service life of the tool effectively, and record the exceeded torque value to clarify the attribution of responsibility for product warranty.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A torque displaying system, comprising:
an input unit receiving a torque signal sensed by a torque tool selectively coupled to a torque multiplier, and receiving a preset torque value or a magnification parameter value corresponding to the torque multiplier inputted by a user;
an operation unit coupled to the input unit, computing a torque value according to the torque signal that is sensed by the torque tool without coupling the torque multiplier or computing a magnified torque value corresponding to the torque multiplier according to the torque signal that is sensed by the torque tool coupled to the torque multiplier and the magnification parameter value inputted by the user;
a display unit coupled to the operation unit, displaying the torque value, the preset torque value, the magnified torque value, the magnification parameter value, a limit torque value which the torque tool is capable to bear, the torque value exceeding the limit torque value, or the magnified torque value exceeding the limit torque value; and
a warning unit coupled to the operation unit, providing a warning signal when the computation of the torque value or the magnified torque value is completed, or the computed torque value or the magnified torque value is equal to the preset torque value, or the torque value or the magnified torque value is approaching or greater than the limit torque value.

2. The torque displaying system of claim 1 applied to a digital display type torque tool or a torque testing instrument including a manual, electric, pneumatic or hydraulic driving type torque tool or torque testing instrument.

3. The torque displaying system of claim 1 further comprising a memory unit coupled to the operation unit for storing a plurality of magnification parameter values corresponding to a plurality of model numbers of the torque multipliers respectively, and the input unit is provided for a user to select one of the magnification parameter values.

4. The torque displaying system of claim 3, wherein when the input unit receives the model number corresponding to the torque multiplier and inputted by the user, the operation unit computes the magnification parameter value corresponding to the torque multiplier according to the model number, displays the magnification parameter value on the display unit, and saves the magnification parameter value in the memory unit.

5. The torque displaying system of claim 3, wherein the limit torque value of this torque tool is saved in the memory unit, and the memory unit is further provided for recording the torque value or the magnified torque value which is greater than the limit torque value.

6. The torque displaying system of claim 3, wherein the operation unit further determines if it is necessary to couple the torque tool to a torque multiplier in order to reach the preset torque value according to the inputted preset torque value and the limit torque value, and when it is necessary to couple the torque tool to a torque multiplier, then the display unit displays the model number or the magnification parameter value of the torque multiplier that is able to reach the preset torque value so as to remind the user to select an appropriate torque multiplier.

7. The torque displaying system of claim 3, further comprising an angular motion sensing unit, continuously sending an angular motion signal to the input unit so as to configure the operation unit to compute an instantaneous torque value corresponding to the angular movement motion of the torque tool according to the angular motion signal.

8. The torque displaying system of claim 7 wherein the input unit continuously receives the angular motion signal, when the user uses the torque tool selectively coupled to the torque multiplier to detect the tightening torque of a fastener and the angular movement that the user rotates the torque tool to drive the fastener and reach a predetermined angular movement, the operation unit computes the a first instantaneous torque value applied on the torque tool or the torque multiplier at the moment when it reaches a predetermined angular movement of the fastener according to the torque signal sensed by the input unit, and the display unit displays the first instantaneous torque value and the predetermined angular movement.

9. The torque displaying system of claim 8, wherein when the angular movement that the user rotates the torque tool to drive the fastener and exceeds the predetermined angular movement, the operation unit not only computes the first instantaneous torque value applied to the torque tool or the torque multiplier at the moment that the user rotated the torque tool to drive the fastener and reach the predetermined angular movement, but also computes the second instantaneous torque value applied on the torque tool or the torque multiplier at the moment that the user stop rotating the torque tool and secure a final angular movement, and the display unit displays or alternately displays the first instantaneous torque value, the predetermined angular movement, the second instantaneous torque value and the final angular movement.

10. A torque displaying method applied to a digital display type torque tool or torque testing instrument, and the torque display method comprising the steps of:
receiving a preset torque value inputted from an input unit by a user;
receiving from the input unit a torque signal sensed by the torque tool or the torque testing instrument which is selectively coupled to a torque multiplier, or further receiving a magnification parameter value corresponding to the torque multiplier and inputted by the user or selected from a memory unit;
using an operation unit to compute a torque value according to the torque signal sensed by the torque tool or the torque testing instrument which is not coupled to the torque multiplier, or using the operation unit to compute a magnified torque value that is magnified by the torque multiplier according to the torque signal sensed by the torque tool or the torque testing instrument which is coupled to the torque multiplier and the magnification parameter value inputted by the user;
using a display unit to display the torque value, the preset torque value, the magnified torque value, the magnification parameter value, an admissible limit torque value of the torque tool or the torque testing instrument, the torque value greater than the limit torque value, or the magnified torque value greater than the limit torque value; and
using a warning unit to alert the user as soon as the computation of the torque value or the magnified torque value is completed or the torque value or the magnified torque value reaches the preset torque value.

11. The torque displaying method of claim 10, wherein when the input unit receives a model number corresponding to the torque multiplier and inputted by the user, the operation unit computes the magnification parameter value corresponding to the torque multiplier according to the model number, displays the magnification parameter value on the display unit, and saves the magnification parameter value in the memory unit.

12. The torque displaying method of claim 10, wherein the limit torque value is saved in the memory unit, and when the torque value or the magnified torque value is approaching or greater than the limit torque value, the warning unit issues a warning signal, and the memory unit records the torque value or the magnified torque value which is greater than the limit torque value.

13. The torque displaying method of claim 10, wherein the operation unit further determines if it is necessary to couple the torque tool or the torque testing instrument to the torque multiplier in order to reach the preset torque value according to the inputted preset torque value and the limit torque value; when it is necessary to couple the torque tool or the torque testing instrument to the torque multiplier, then the model number or the magnification parameter value of the torque multiplier that is able to reach the preset torque value will be displayed on the display unit.

14. The torque displaying method of claim 10, further comprising the following step:
continuously sending an angular motion signal to the input unit by an angular motion sensing unit so as to configure the operation unit to compute an instantaneous torque value corresponding to the angular movement of the torque tool.

15. The torque displaying method of claim 14, wherein the input unit continuously receives the angular motion signal, when the user uses the torque tool selectively coupled to the torque multiplier to detect the tightening torque of a fastener and the angular movement that the user rotates the torque tool reaches a predetermined angular movement of the fastener, the operation unit computes the first instantaneous torque value applied to the torque tool or the torque multiplier at the moment according to the torque signal sensed by the input unit, and the display unit displays the first instantaneous torque value and the predetermined angular movement simultaneously or alternately.

16. The torque displaying method of claim 15, wherein, when calibrating a high torque tightened fastener, the digital display type torque tool with the angular motion sensing unit and coupled to a torque multiplier needs to be in use; the predetermined angular movement to be updated and inputted in the digital display type torque tool should be set as the product of the angular movement to be defined on the fastener and multiplied by the gear ratio of the torque multiplier to be used.

17. The torque displaying method of claim 15, wherein, when the angular movement that the user rotates the torque tool exceeds the predetermined angular movement, the operation unit not only computes the first instantaneous torque value applied to the torque tool or the torque multiplier at the moment that the user rotates the torque tool and drives the torque tool to the predetermined angular movement, but also computes the second instantaneous torque value applied on the torque tool or the torque multiplier at the moment that the user stops rotating the torque tool to a final angular movement, and the display unit displays or alternately displays the first instantaneous torque value, the predetermined angular movement, the second instantaneous torque value and the final angular movement.
